(19) United States
(12) Patent Application Publication
(10) Pub. No.: US 2015/0033247 A1
(43) Pub. Date: Jan. 29, 2015

(54) PROVIDING PERSONALIZED ADVERT AND GROUP PURCHASING TO TELEVISION VIEWERS

(71) Applicant: Comigo Ltd., Moshav Yarkona (IL)

(72) Inventor: Motty Lentzitzky, RaAnana (IL)

(21) Appl. No.: 14/378,108

(22) PCT Filed: Feb. 28, 2013
(86) PCT No.: PCT/IL13/50186

§ 371 Date: Aug. 12, 2014

Related U.S. Application Data
(60) Provisional application No. 61/605,220, filed on Mar. 1, 2012.
(60) Provisional application No. 61/607,615, filed on Mar. 7, 2012.

(51) Int. Cl. H04N 21/2668; H04N 21/442; H04N 21/81; H04N 21/45; H04N 21/258; H04N 21/254

(52) U.S. Cl. CPC H04N 21/2668; H04N 21/25891; H04N 21/2542; H04N 21/812; H04N 21/4532; H04N 21/44222
USPC 725/13; 725/34

(57) ABSTRACT

A method of personalizing commercial content to be presented to a media consumer, comprising, creating a personal profile of a media consumer, the personal profile reflects real time interaction of said media consumer with media content received from a media provider and presenting a personalized commercial content to the media consumer according to the personal profile.

### RELATED APPLICATION

This application claims the benefit of priority under 35 USC §119(e) of U.S. Provisional Patent Application No. 61/605,220 filed 1 Mar. 2012 and Provisional Patent Application No. 61/607,615 filed 7 Mar. 2012, the contents of which are incorporated herein by reference in their entirety.

### BACKGROUND

The present invention, in some embodiments thereof, relates to providing personalized advert viewing and group purchasing functionality to television viewers of television and, more specifically, but not exclusively, to personalizing commercial content and group purchasing products and/or services according to a personal profile of the television viewer.

Television is one of the broadest reaching advertising medium and a major player in the arena of digital media content. The majority of households in the developed countries (industrialized countries) in general and in the United States (US) in particular have at least one television set. Recent studies show that an average adult spends several hours a day watching television.

Television commercials are capable of presenting businesses, products and/or services to a wide audience, usually reaching the potential consumers television viewers at their most attentive and alert time. Conveying the message through visual, sound and motion effects, the television offers the best platform for engaging the consumer in the advertised goods. However, television advertising lacks the ability to efficiently segment the audience of television viewers in order to reach the relevant potential consumers of the advertised goods. In addition presenting non appealing advertisement of businesses, products and/or services to television viewers results in the advertisements becoming an annoyance and is ignored all together by television viewers.

Personalizing the commercial content that is presented to a television viewer based on his preferences, interests and/or his interaction with the media content and/or the commercial content may result in better segmentation of the audience consuming media contents through the television to have more effective commercial campaigns.

### Customizing

Group purchasing is a widely spreading means for purchasing products and/or products. Group purchasing is beneficial to both the seller which can secure a large sale of the goods he offers and for the buyer as purchasing in large quantities provides better purchasing terms, for example lower price, extended warranty and/or better delivery time. Group purchasing requires a plurality of individuals to group together in order to purchase a specific one or more service and/or product.

Enabling a plurality of television viewers to group together for the purpose of purchasing a product and/or a service presents many advantages. More specifically, television viewers may interact with each other to form and/or join a purchase group according to mutual preferences and/or according to interaction with the media content and/or the commercial content. Purchase groups may be formed and/or joined while relevant advert is presented on television making the purchase group much more accessible and appealing as it may be done in real time and it meets the interests and preferences of the television viewers.

### SUMMARY

According to some embodiments of the present invention, there are provided systems and methods of personalizing commercial content to be presented to a media consumer. A personal profile is created to reflect real time interaction of a media consumer with media content received from a media provider. The personal profile is used to create and present a personalized commercial content to the media consumer. The personalized commercial content includes one or more of the following, advert, promotion data and purchase offer.

Optionally, the media content includes content received from one or more other media consumers to be analyzed and included in the personal profile.

Optionally, the personal profile is created by a software module that analyzes the personal profile to create the personalized commercial content.

Optionally, the media consumer interacts in real time with one or more vendor that offers at least one item that is presented in the personalized commercial content. Interaction between the media consumer and the one or more vendors is enabled by a software module that communicates in real time with the one or more vendor using another instance of the software module.

Optionally, the media consumer interacts in real time with one or more other media consumers at a remote location that is interested in at least one item that is presented in the personalized commercial content. Interaction with the one or more other media consumers is enabled by a software module that communicates in real time with one or more other media consumers using another instance of the software module.

Optionally, a description of the media content is received from the media provider to be used to create the personalized commercial content. The description may include the time period during which the presenting takes place.

According to some embodiments of the present invention, there is provided an interaction software module for tracking the interaction of the media consumer with the media content that is presented. The interaction software program monitors and analyzes real-time interaction of the media consumer with media content received from the media provider and presents the personalized commercial content to the media consumer according to the monitored interaction and. The interaction software module is executed by a processing unit of a client terminal that identifies the media contents that is presented to the media consumer. The personalized commercial content is selected from a plurality of commercials received from the media provider.

Optionally, the software program interacts in real time with one or more other media consumer to share one or more items that are presented in the personalized commercial content.

Optionally, the interaction software module shares a common data repository with a plurality of interaction modules executed on a plurality of client terminals.

According to some embodiments of the present invention, there is provided a joint session software program for sharing a personalized commercial content session between two or more media consumers. The joint session software program monitors and analyzes the interaction of two or more media consumers with media content received from the media provider, present the personalized commercial content to the two or more media consumers according to the interaction and enabling the two or more media consumers to join into a session according to the interaction for the purpose of communicating with respect to one or more item in the personalized commercial content; The joint session module is executed by a processing unit of a client terminal that identifies the media contents that is presented to the media consumer. The joint session software module communicates with one or more other client terminal that executes the joint session software module.

Optionally, the joint session logs previous interaction of two or more media consumers with said media content.

Optionally, the joint session module shares a common data repository with a plurality of joint session modules executed on a plurality of client terminals.

Optionally, the personalized joint session is a purchasing group for pursuing purchase offers for one or more items that are presented in the personalized commercial content.

According to some embodiments of the present invention, there is provided a client terminal for personalizing commercial content that includes a communication component which receives commercial content from a media provider, a processing component for monitoring interaction of the media consumer with media content received from the media provider to create the personalized commercial content to be presented to the media consumer and a media interface component for transmitting the personalized commercial content to a media device.

Optionally, the client terminal includes a user interface component for interacting with the media consumer in order to create a personal profile of the media consumer to be used to create the personalized commercial content.

Optionally, the client terminal includes a memory component for storing the personal profile. The memory component may be accessed by the processor component to analyze the personal profile in order to create the personalized commercial content. The memory component may be used for storing commercial content that is received from the media provider to create the personalized commercial content by selecting one or more items of the commercial content.

According to some embodiments of the present invention, there is provided a method of presenting personalized commercial content to the media consumer by updating the personal profile of the media consumer to reflect real time interaction of the media consumer with at one or more media consumer and presenting a personalized commercial content to the media consumer according to the personal profile.

According to some embodiments of the present invention, there is provided a method of tracking real time interaction of the media consumer with media content by monitoring real time interaction of the media consumer with media content that is received from the media provider, analyzing the real time interaction to identify interests of said media consumer and creating personalized commercial content to meet the interests of the media consumer.

Optionally, previous interaction of the media consumer with the media content is analyzed so as to identify ongoing interests of the interaction.

According to some embodiments of the present invention, there is provided a method of tracking real time interaction of the media consumer with one or more other media consumers by monitoring real time interaction of the media consumer with one or more other media consumers, analyzing the interaction to identify social interests of the and creating personalized commercial content to meet the social interests of the media consumer.

According to some embodiments of the present invention, there is provided a method of presenting personalized commercial contents to the media consumer by monitoring real time interaction of a media consumer with the media content that is received from the media provider, retrieving previous interaction of the media consumer with media content that was received from a media provider, analyzing the real time interaction and the previous interaction of the media consumer to identify interests of the media consumer and creating personalized commercial content to meet the interests of the media consumer.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of an exemplary process for personalizing commercial content, according to some embodiments of the present invention;

FIG. 2 is a schematic illustration of an exemplary system for personalizing commercial content to be presented to a media consumer, according to some embodiments of the present invention;

FIG. 3 is a schematic illustration of an exemplary distributed system for personalizing commercial content to be presented to a media consumer, according to some embodiments of the present invention;

FIG. 4 is a schematic illustration of an exemplary system for personalizing commercial content executing exemplary software modules, according to some embodiments of the present invention;

FIG. 5 is a flowchart of an exemplary process for presenting personalized commercial content to a media consumer, according to some embodiments of the present invention;

FIG. 6 is a flowchart of an exemplary process for group purchasing, according to some embodiments of the present invention; and

FIG. 7 is a flowchart of an exemplary process for posting a new group purchasing, according to some embodiments of the present invention.

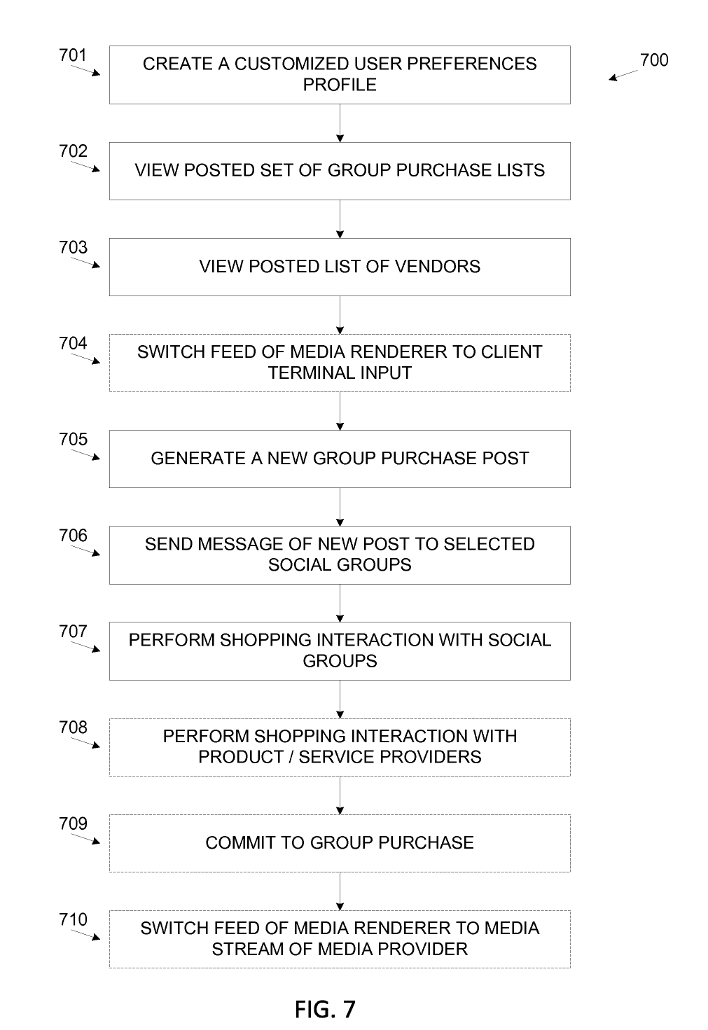

### DETAILED DESCRIPTION

The present invention, in some embodiments thereof, relates to personalizing commercial content to be presented to a media consumer and, more specifically, but not exclusively, to monitor the interaction of the media consumer with the presented media contents in order to personalize the advert content that is present to the media consumer. Commercial content may include, for example, presentation of business, products and/or services, promotion and/or offers for group purchases.

In addition, commercial content may include non-commercial content, for example, contents created by one or more media providers, lists of purchasing groups and/or private contents that is shared between one or more media consumers.

The personalized commercial content may be presented to the media consumer through a media renderer, for example, television, tablet, Smartphone and/or computer.

According to some embodiments of the present invention, there are provided systems and methods, devices and software programs for personalizing commercial content to a media consumer, for example, a television viewer, according to the interaction of the media consumer with the media content that is presented to him. A personal profile is created for the media consumer according to the interaction activity he holds with the media content. The personal profile may be further updated to include interaction the media consumer holds with one or more other media consumers with respect to presented media contents and/or commercial content. Interaction of the media consumer with the media contents and/or the commercial content may include, for example, looking up for information, ordering products and/or services, placing bets and/or joining a chat. The media consumer may interact in real time with one or more vendors offering one or more items that are included in the personalized commercial content that the media consumer views. The media consumer may interact in real time with one or more other media consumers with respect to a personalized commercial content that is presented to one or more of the media consumers. One or more media consumers may join together in real time with respect to the personalized commercial content that is presented to one of more of the media consumers. The one or more media consumers may, for example, chat among themselves, recommend businesses, products and/or services to each other, join a purchasing groups and/or form new purchase groups.

Optionally, group purchasing offers may be presented to the media consumer based on real time interaction of the media consumer with the media content and/or with other one or more media consumers. Purchase group offers may be predicted according to real time interaction between the media consumer with the commercial content and/or the interaction with other media consumers.

Optionally, a plurality of social sets are created, each social set includes two or more media consumers. The social set may include two or more selected media consumers, for example, members of a media network, family members and/or friends. The social set may be created by one or more of the media consumers. The social set may be automatically generated to include media consumers who share common interests, for example, they have a common personal profile, they interact with each other and/or they interact with the same commercial content. The one or more social sets may be introduced with personalized advert, for example, offers for group purchasing according to the interaction of the one or more media consumer members with the presented media content and/or commercial content. The personalized commercial content may also be presented to the media consumers members of the social set according to mutual characteristics of the personal profile of the media consumers members.

Optionally, a presentation of personalized commercial content may be split to two or more separate advert items presented on the same media renderer 240.

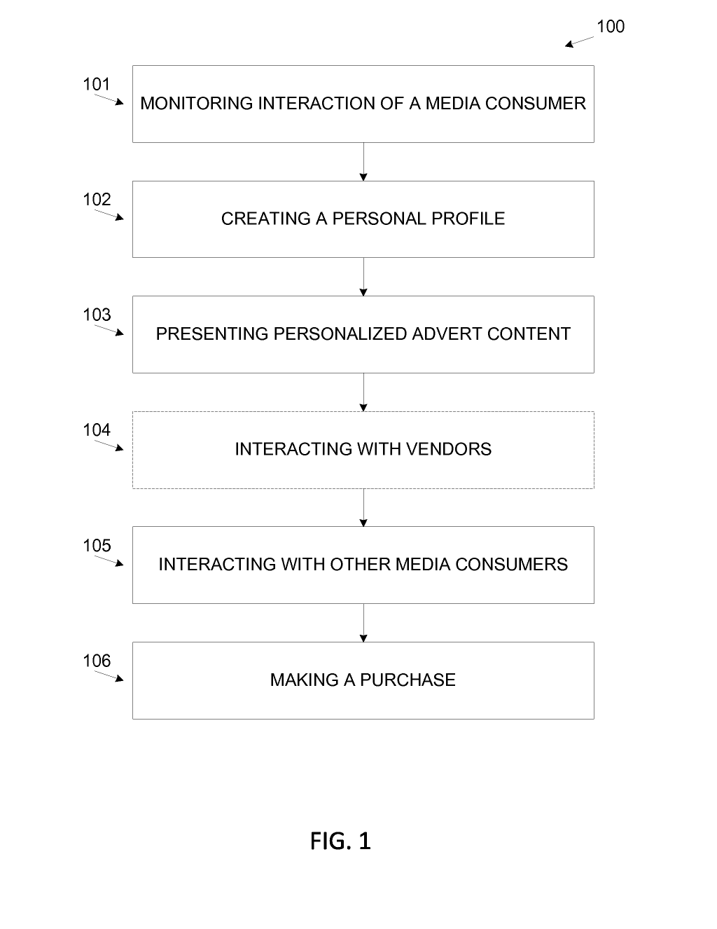

Reference is now made to FIG. 1 which is a flowchart of an exemplary process for personalizing commercial content, according to some embodiments of the present invention.

As shown at 101, interaction activity of the media consumer with media contents and/or commercial is monitored.

Optionally, the collected interaction activity information is limited to interaction that relates to the personalizing commercial content. That is to provide better analysis by avoiding irrelevant interaction that may interfere with characterizing the interest of the media consumer in the presented personalizing commercial content.

Optionally, the interaction activity is logged and stored. The stored interaction data may be used for future presentation of personalizing commercial content.

As shown at 102, the interaction information may be analyzed to create a personal profile of the media consumer to identify interests of the media consumer in order to create appropriate personalized commercial content. The personal profile may include history of interaction of the media consumer with the media content and/or the commercial content may include for example, the products and/or services the media consumer was interested in and/or type of media contents the media consumer is following. Maintaining interaction history may result in a more effective and appealing personalized commercial content. The personal profile may also include interaction of the media consumer with one or more other media consumers. The interaction of previous interaction of the media consumer with one or more other media consumers may also be logged and stored. The personalizing commercial content may be created according to the interaction the media consumer had with the media contents and/or with one or more other media consumers. For example, presenting an offer to purchase a baseball hat during a broadcast of a baseball match. Another example may be, presenting an offer to purchase a baseball hat that one or more other media consumers are purchasing at this time, where the other one or more media consumers interacted in the past with the media consumer with respect to baseball merchandize.

As shown at 103, the personalizing commercial content is presented to the media consumer. Presentation of the personalizing commercial content may be coordinated with a media stream received from a media provider, for example, presenting the personalizing commercial content during a commercials break and returning to the original media stream from the media provider at the end of the commercials break.

Optionally, as shown at 104, the media consumer interacts in real time (while viewing the personalizing commercial content) with one or more vendors offering one or more items that are presented to the media consumer.

Optionally, as shown at 105, the media consumer interacts in real time (while viewing the personalizing commercial content) with one or more other media consumers, for example, friend, family member, a member of a social network and/or a random media consumer who are interested in the same product and/or service. The media consumer may share with the one or more media consumers one or more items that were presented in the personalizing commercial content. The media consumer may, for example, recommend one or more items to another media consumer and/or join with other media consumers to a purchasing group.

Optionally, one or more media consumers may engage in a joint session with respect to the media content and/or the personalizing commercial content that is being presented to one or more of the media consumers, for example, chat, invite one or more other media consumers to a purchasing group and/or place bets in real time on a sports event.

Optionally, joint sessions may be automatically initiated according to the personal profile of one or more of the media consumers. For example, the personalizing commercial content of a certain media may be adjusted to include items that are of interest to another media consumer who interacts with the certain media consumer.

Optionally, as shown at 106, the media consumer makes a purchase of a product and/or a service that was presented to him. Purchasing may be carried out through interaction with a vendor offering the product and/or service and/or through joining a purchase group and committing to purchase.

Some embodiments of the present invention, are presented herein by means of an example, however the use of this example does not limit the scope of the present invention in any way.

A first example relates to interaction that is conducted between two or more media consumers during a football match between Barcelona and Chelsea.

One or more of the media consumers create a joint session to invite one or more other media consumers to watch the football match together (virtual invitation). Two or more of the media consumers that participates in the joint session may chat with each other. One or more media consumers may comments on the match through the joint session.

Furthermore, interaction may be conducted with respect to the media content, i.e. the football match. One or more media consumers may bet on a specific event to take place, for example, which player will score the next goal and/or which player will get a yellow card. One or more of the media consumers may interact in a trivia game with respect to the football match, for example, how many times have the teams met before, what was the score of the last match the two teams played in and/or which player scored the highest number of goals this season. Two or more media players may join in a survey, for example, which team is your favorite team and/or which player is your favorite player.

The interaction activity information is collected during the football match and analyzed to identify the interests and/or preferences of one or more media consumers. Based on the analysis of the interaction data, personalized commercial content may be presented to one or more of the media consumers participating the joint session, for example, adverts for merchandize. The collected information may include previous interaction activity that was logged and stored. The advert and/or merchandize may be correlated to the media content that is currently being displayed, i.e. the football match. For example, identifying that one or more media consumers likes Barcelona, he may be presented with adverts for purchasing a Barcelona player's T-Shirt. Moreover, the media consumer who was presented with the advert may invite another one or more media consumers in the joint session to purchase the T-Shirt and get a discount for group purchasing.

A second example relates to ordering pizza and beer. One or more media consumers are watching a reality show at remote locations. During previous broadcasts of the reality show, one or more of the media consumers participating in the joint session ordered pizza and beer. Analyzing previously collected and stored interaction activity information, an offer may be presented to one or more media consumers in the joint session to purchase pizza and beer. The media consumer may invite one or more other media consumers in the joint session so as to make a group purchase from the same vendor and get a discount. Furthermore the offer may be presented prior to the broadcast time of the reality show.

Personalizing commercial content may be carried out through one or more software application modules executing on a client terminal. The software application modules may facilitate the ability to track in real time the interaction of a plurality of media consumers in order to personalize the commercial content that is presented to the media consumers. The software application modules may communicate with a central server and/or with a plurality of other client terminals executing the same and/or compatible software application modules.

The software modules may share a common data repository for sharing interaction information of the plurality of media consumers. The common repository may be facilitated, for example, by a backend server of a software application service provider, a central server of the media provider and/or a third party offering infrastructure services.

The software modules may receive in real time a description of the media content that is being viewed by the media consumer, for example, sports event, reality show and/or life style show.

The software modules may track in real time the interaction the media consumer makes with the media contents, for example, channels switching during a show, search for commodities relating to the presented media content and/or interaction with other media consumers during commercial content presentation. The software module may also track in real time the interaction the media consumer makes with commercial content, for example, channels switching during a commercial break, search for commodities relating to the presented commercial content, interaction with vendors and/or interaction with other media consumers during commercial content presentation. Collecting this information of the media consumer interaction enables efficient personalization of the commercial content that is presented to the media consumer.

The software modules may monitor the entire viewing environment of the media consumer including, for example, the media content, the interaction the media consumer is holding with other media consumers and/or interaction with vendors. Based on the accumulated data the software application may be able to produce an accurate personal profile of the media consumer and provide appropriate personalized commercial content.

Software modules may enable the media consumer to interact in real time with a vendor offering one or more items that are part of the personalized commercial content that the media consumer is viewing. The software module may also enable the media consumer to interact with one or more media consumers at remote locations with respect to advert media content that is presented to one or more of the media consumers. The media consumer may contact in real time another media consumer, for example, share information on one or more items of the personalized commercial content join a purchasing group and/or invite one or more other media consumers to a purchasing group. Interaction may also be initiated automatically, to join one or more media consumers in a joint session, for example, forming a purchasing group.

Optionally, previous interaction of the media consumer with the media content and/or the commercial content is logged and stored. The stored interaction data may be analyzed and used to better focus on the predict of commercial content to be presented to the media consumer, for example, during a previous sports game of a favorite team the media consumer ordered a hat of the team, so an offer to purchase another merchandize item of the team may be posted to the media consumer.

Optionally, interaction of the media consumer with other media consumers is logged and stored. Mutual interaction may enable posting personalized commercial content which was shared in the past between the media consumer and one or more other media consumers. For example, during a previous reality music show, one or more media consumers shared information with respect to merchandize of a singer performing on the show so in case one of the media consumers is currently viewing the show and is interested in purchasing a T-Shirt of the same singer so during a current music show a post offering purchase of a dress of the singer may be posted to the one or more other media consumers.

Optionally, interaction of the media consumer with the personalized commercial content is limited to the presented media content and/or the commercial content so as to make the analysis of the interaction activity more effective.

Optionally, a software module is associated with a genre of the media content, for example, a specific software module is initiated during a sports event and/or another software module is initiated during a life style show.

Some embodiments of the present invention are described below with reference to flowchart illustrations and/or block diagrams of methods, apparatus (systems) and computer program products according to embodiments of the invention.

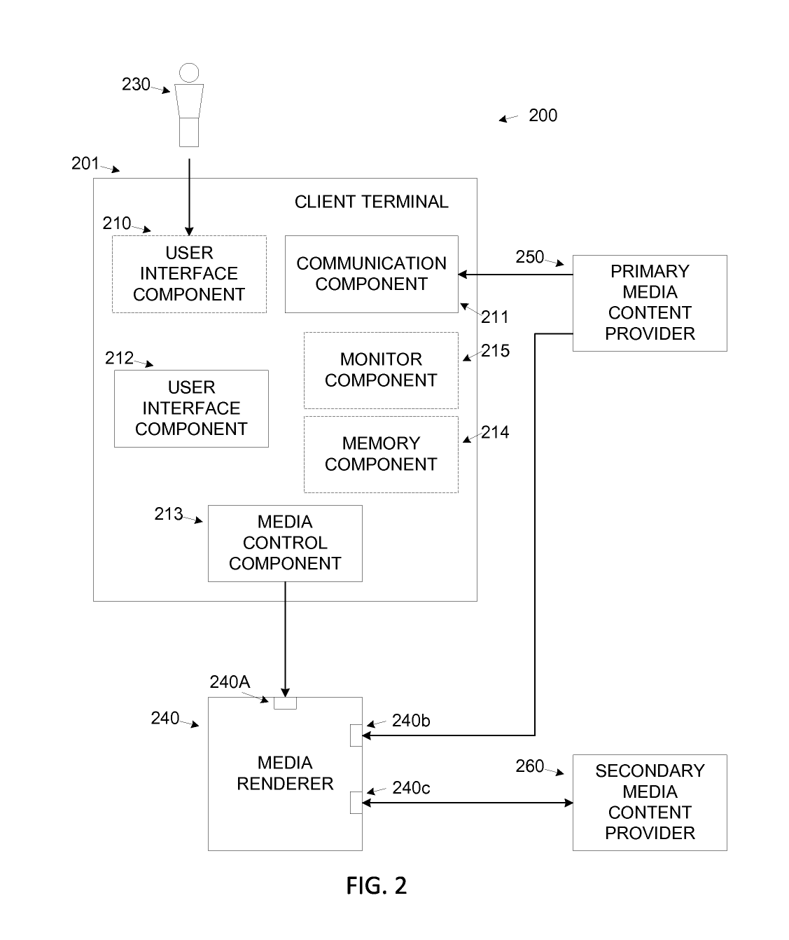

Reference is now made to FIG. 2 which is a schematic illustration of an exemplary system for personalizing commercial content to be presented to a media consumer, according to some embodiments of the present invention. A system 200 includes a client terminal 201 which is used for personalizing the commercial content to a media consumer 230. The client terminal 201 includes a communication component 211 for communicating with a media provider 250, a processor component for creating and/or controlling the personalized commercial content that is presented to the media consumer 230 and a media control component that connects to a media renderer 240.

The client terminal may be utilized through a plurality of devices, for example, custom proprietary device, set top box (STB), Smartphone, Smart TV, tablet and/or computer.

The client terminal 201 includes a processor component 212 that may be used to create and/or control the presentation of the personalized commercial content on the media renderer 240 according to the interaction of the media consumer with the presented media content and/or the commercial content and/or according to the personal profile. The processor component 212 may receive a description of the media contents that is received from the media provider 250, for example, sports event, reality show and/or life style show. The description of the content may be used by the processor component 212 to create appropriate personalized commercial content.

Optionally, the processor component 212 may also execute one or more software modules for interacting with a plurality of remote media consumers using a plurality of client terminals.

At the appropriate time a media consumer 230 is presented with the personalized commercial content that was created by the processor 212. The client terminal may be notified by a media provider 250 of the appropriate time for presentation through the communication component 211, for example, a commercials break. During the appropriate time for presentation the processor component 212 transmits the personalized commercial content to the media renderer through the media control component 213.

Optionally, the media control component 213 controls the media renderer 240 in order to switch between video/audio stream input ports 240A, 240B and/or 240C which may be available by the media renderer 240. The media stream received from the media provider 250 may be received at the media renderer 240 through the input port 240B. At the appropriate time for presentation the media control component 213 may switch the input of the displayed media to the port 240A. The personalized commercial content is then transmitted from the client terminal 201 to the media renderer 240.

Optionally, the client terminal includes a user interface component 210 that is used to interact with the media consumer 230. Interaction may include customization of the personal profile. Customization may include, for example, the level of personalization level that the media consumer 230 desires, for example, no personalization at all, full personalization and/or specific level of personalized commercial content. Another example may be the presentation method of the displaying the personalized commercial content with respect to the original media content received from the media provider 250, for example, replace original stream and/or overlaid over the original media contents.

Optionally, the media consumer 230 interacts with the client terminal 101 to engage in an interaction with one or more other users 230 and/or one or more vendors. The user interface may include a plurality of human interfaces to allow the media consumer 230 to communicate with the client terminal 201, for example, keyboard, pointing device, remote control, joy stick, touch screen, audio interface and/or voice recognition interface.

Optionally, the media consumer 230 interacts with the client terminal 201 through external devices connecting to the client terminal 201, for example, Smartphones, tablets and/or laptop computers.

Optionally, the client terminal 101 uses the media renderer 240 for interacting with the user 230, for example using the display of the media renderer for visual and audio output, using the remote control of the media renderer as input and/or using the touch screen of the media renderer for input in case this feature is supported by the media renderer.

Optionally, the client terminal 201 includes a memory component 214 that is used for storing the personal profile of the media consumer 230. The memory may also be used for storing commercial content that is used by the processor component 212 for creating the personalized commercial content.

Optionally, the personal profile of the media consumer is stored at a remote site, for example at the site of the media provider 250 and/or a third party site. When stored at a remote location, the personal profile may be transmitted to the client terminal 201 to be used by the processor component 212 for controlling the presentation of the media advert on the media renderer.

Optionally, the client terminal 201 includes a monitor component 215 which monitors the media contents received from the media provider 250. The monitor component 215 may be capable of identifying the media contents characteristics, for example type of media content, for example, sports, cooking, life style and/or reality. The monitor component 215 may identify the contents of the media contents more specifically, for example, identify it is a football match between Barcelona and Chelsea. The identified information may be used by the processor component to create the personalized commercial content to be presented to the media consumer 230.

Optionally, the client terminal 201 receives all the media content (not only commercial content) from the media provider 250 and transmits it to the media renderer through media control component 213 that connects to the port 240A.

Optionally, the client terminal 201 controls additional input ports of the media renderer, for example the interface port 240C through which another stream of media content may be received from a secondary media provider 260.

Optionally, a light weight interaction software application module is executed on the processor component 212. The interaction application monitors in real time the interaction of the media consumer 230 with the media content and/or the commercial content in order to create personalized commercial content. The interaction application may use the personal profile to analyze previous interactions of the media consumer 230 with the media contents and/or commercial content to provide purchasing offers.

Optionally, a light weight joint session software application is executed on the processor component. The joint session application monitors in real time the interaction of the media consumer with the media content and/or the commercial content in order to engage with other one or more remote media consumers 230. The joint session application may communicate with the remote media consumers 230 using the same joint session application and/or a compatible application. The joint session may be formed to enable the media consumer 230 to create, share, invite and/or inform one or more remote media consumers 230 of an event relating to media content and/or commercial content that is currently presented. A joint session may be initiated by one or more media consumers 230 and/or it may be automatically initiated according to interaction of one or more media consumers 230 with media content and/or commercial content. Optionally, a software development kit (SDK) is available to support development of the joint session application.

Optionally, a software development kit (SDK) is available to support development of the interaction software module. The SDK may include for example, application programming interface (API), function calls, libraries and/or development tools which may be used for example, to allow a user to create an interaction software module and/or to interact with the interaction software module.

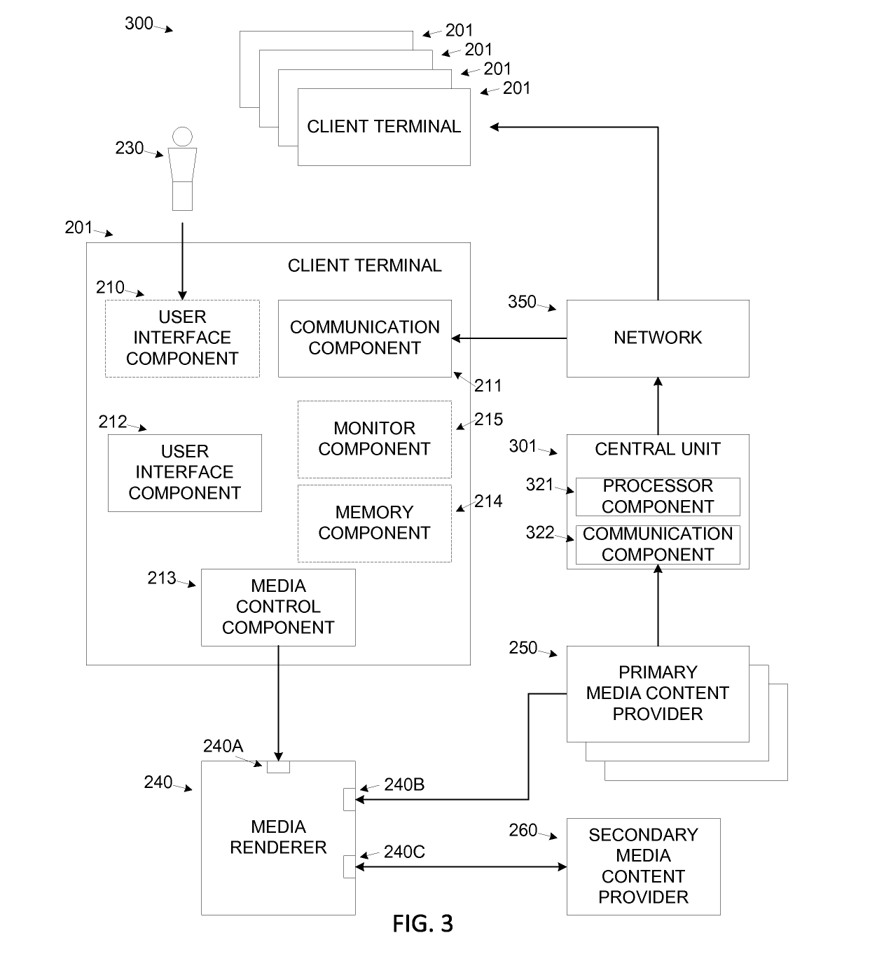

Reference is now made to FIG. 3 which is a schematic illustration of an exemplary distributed system for personalizing commercial content to be presented to a media consumer, according to some embodiments of the present invention. A system 300 includes a central unit 301 for processing the personalized commercial content for one or more media consumers 230. The central unit 301 includes a processor 321 for creating and controlling the plurality of personalized commercial content to be transmitted to the plurality of client terminals 201. The central unit 301 may communicate with the media provider 250 through a communication component 322 to receive a plurality of indications, for example, the nature of the presented media content and/or the time period during which the personalized commercial content may be presented (commercial break). The central unit 301 may transmit a plurality of personalized commercial content through the communication component 322 to a plurality of client terminals 201 over the plurality of networks 350, for example, cellular and/or internet.

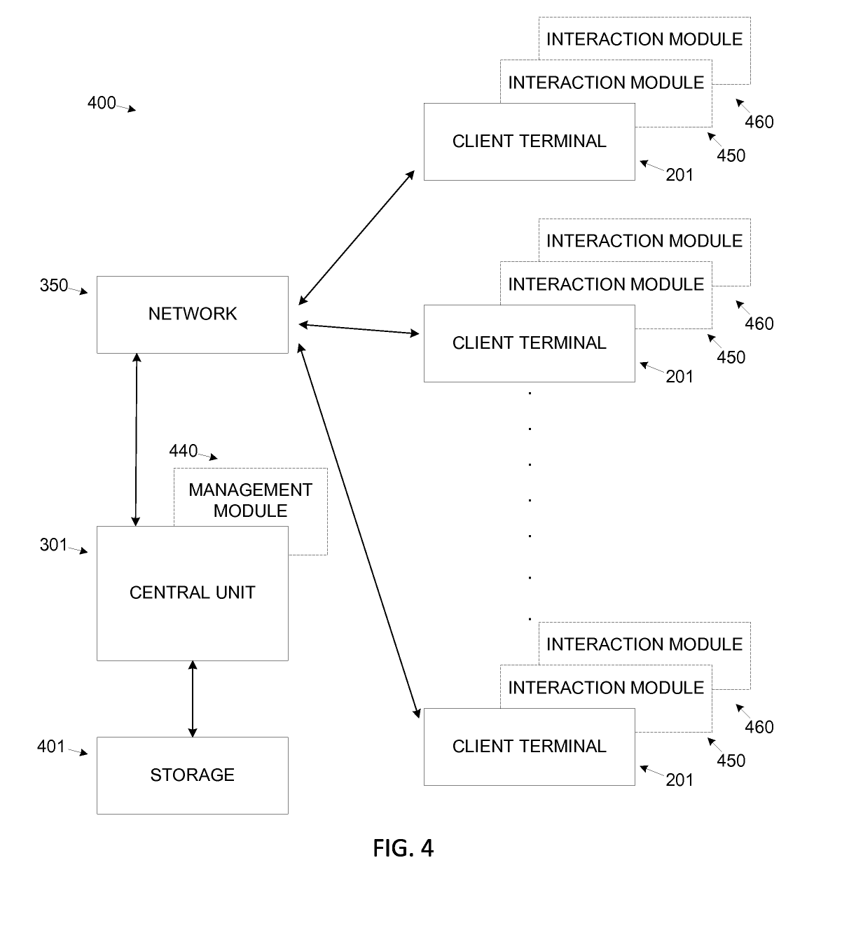

Reference is now made to FIG. 4 which is a schematic illustration of an exemplary system for personalizing commercial content executing exemplary software modules, according to some embodiments of the present invention. A system 400 includes the central unit 301 and a plurality of client terminals 201. The central unit 301 communicates with the plurality of client terminals 201 through one or more of a plurality of networks 350. The plurality of client terminals 201 are connected to a plurality of display renderers 240 to present personalized commercial content to a plurality of users 230.

Each of the plurality of client terminals may execute one or more software modules, for example an interaction software module 450 and/or a joint session software module 460.

The interaction software module 450 which may be executed on any of the client terminals 201 is capable of monitoring in real time the interaction of the respective media consumer 230 that is viewing the contents presented to him by the client terminal. The interaction may be recorded to create a personal profile. The personal profile is then analyzed to present the media consumer 230 with appropriate personalized commercial content. The interaction software module 450 may communicate with the central unit 301 to receive commercial content from which a personalized commercial content is created.

Optionally, a common data repository is maintained for the plurality of media consumers 230. The data repository may be stored in a storage unit 401 that is accessible by the central unit 301. The interaction software module 450 may retrieve from the common data repository a plurality of data items with respect to one or more of the media consumers 310.

The joint session software module 460 which may be executed on any of the client terminals 201 is capable of communicating with other client terminals executing other instances of the joint session software module 460. The joint session software module 460 is capable of joining two or more media consumers 230 to a joint session.

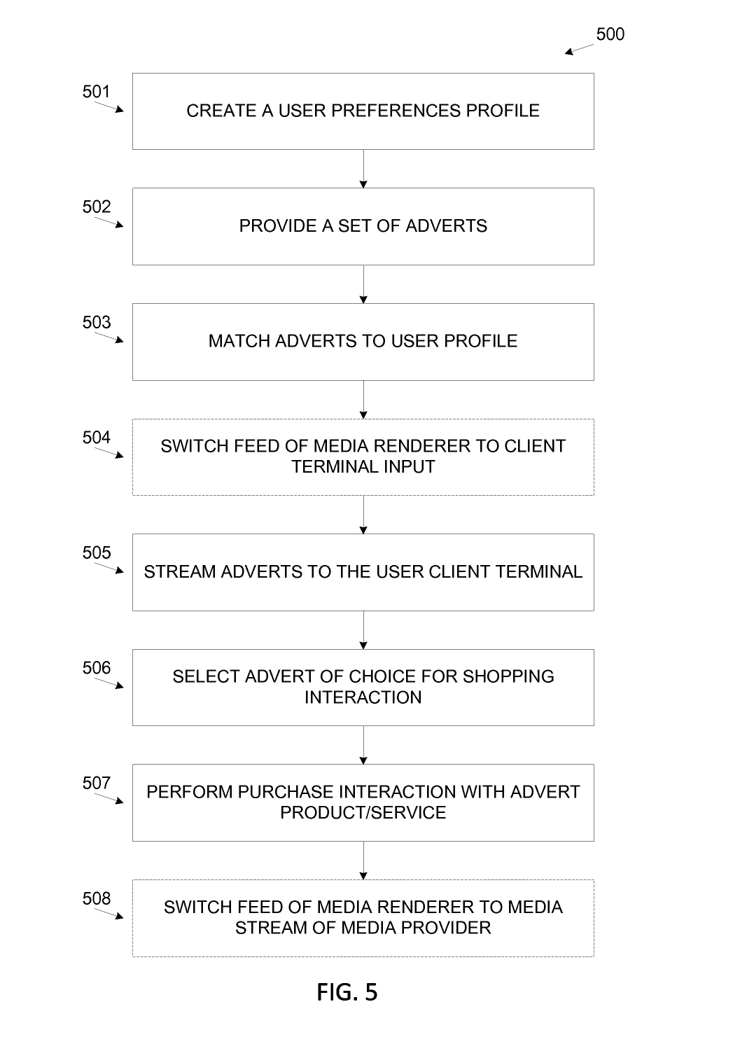

Reference is now made to FIG. 5 which is a flowchart of an exemplary process for presenting personalized commercial content to a media consumer, according to some embodiments of the present invention. A process 500 may be executed locally by the processor component 212 of the client terminal 201, by the processor component 221 of the central unit 301 and/or the process 500 may be distributed between the processor component 212 and the processor component 321.

As shown at 501, a personal profile may be created to reflect interaction of the media consumer 230 with the presented media content and/or the commercial content.

As shown at 502, a plurality of adverts is provided.

Optionally, the plurality of adverts is stored locally at the client terminal 201, for example in the memory component 214.

As shown at 503, the personalized commercial content may be selected from the set of adverts according to real time interaction of the media consumer 230 with the media content and/or the commercial content.

Optionally, the personalized commercial content is created according to the personal profile of the media consumer 230 which provides a log of previous interactions of the media consumer with media content and/or commercial content and/or provides preferences and/or interests of the media consumer 230 with respect to media content and/or commercial content.

As shown at 504, upon indication from the media provider 150, the feed to the media renderer is switched from the original media content stream to the client terminal 101.

As shown at 505, the client terminal 201 transmits the personalized commercial content to be presented to the media renderer 240.

Optionally, as shown at 506, the personalized set of offers is presented to the media consumer 230 on request.

Optionally, as shown at 507, the media consumer 230 interacts with the vendor presenting the offer in order to make a purchase.

As shown at 508, upon another indication from the media provider 150, the feed to the media renderer is switched back from the stream transmitted by the client terminal 101 to the original media content stream received from the media provider 150.

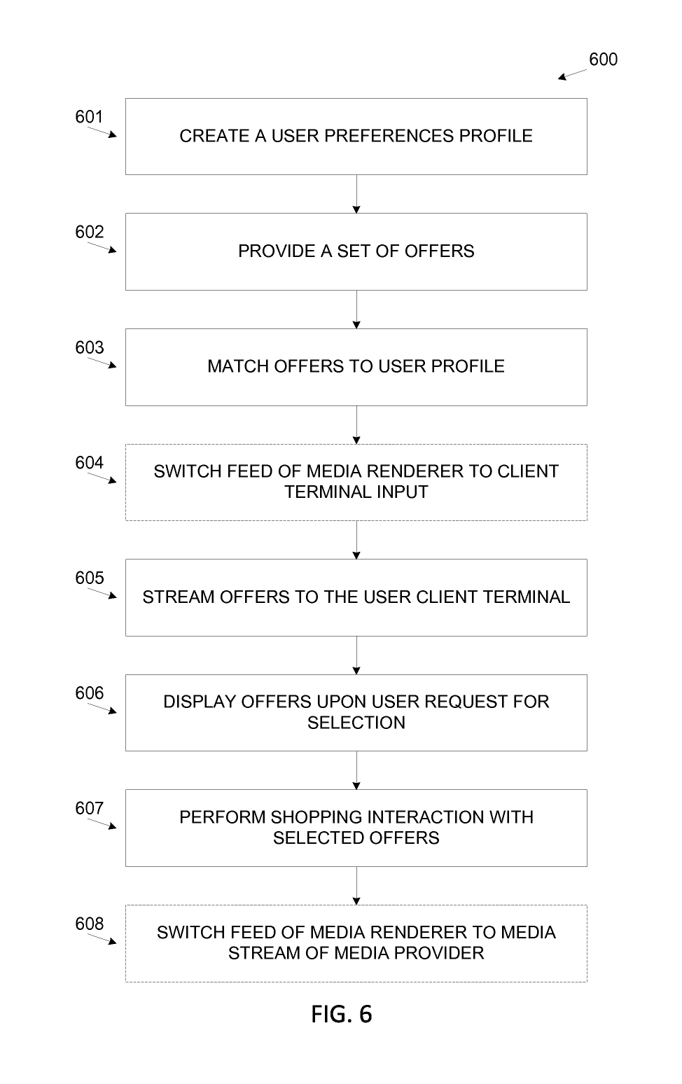

Reference is now made to FIG. 6 which is a flowchart of an exemplary process for group purchasing, according to some embodiments of the present invention. A process 600 may be executed locally by the processor component 212 of the client terminal 201, by the processor component 221 of the central unit 201 and/or the process 600 may be distributed between the processor component 212 and the processor component 221.

As shown at 601, a personal profile may be created to reflect interaction of the media consumer 230 with the presented media content and/or the commercial content.

As shown at 602, a plurality of offers for a plurality of purchase groups is provided. Offers may include a plurality of offer types, for example, daily offers, weekly offers, monthly offers and/or seasonal offers.

Optionally, the plurality of offers is stored locally at the client terminal 201, for example in the memory component 214.

As shown at 603, the set of plurality of offers is filtered and set to match the interaction of the media consumer 230 with the presented media content and/or the commercial content.

Optionally, the personalized set of offers is set with respect to the personal profile of the media consumer 230 which provides a log of previous interactions of the media consumer with media content and/or commercial content and/or provides preferences and/or interests of the media consumer 230 with respect to media content and/or commercial content. The set of offers may also be set for a media consumer 230 according to interaction he had with another media consumer 230 who is currently engaged with a relevant offer. For example, a specific media consumer 230 was in contact in the past with one other media consumer 230 with respect to purchasing a pizza during a cocking show. The other media consumer 230 is currently engaged in purchasing a pizza while a cocking show is on. A joint session may be automatically initiated to engage the two media consumers 230 in an offer for purchasing a pizza again.

As shown at 604, upon indication from the media provider 150, the feed to the media renderer is switched from the original media content stream to the client terminal 101.

As shown at 605, the client terminal 201 transmits the personalized set of offers to be presented to the media renderer 240.

Optionally, as shown at 606, the personalized set of offers is presented to the media consumer 230 on request.

As shown at 607, the media consumer 230 interacts with one or more other media consumers 230 and/or with one or more vendors responding to one or more of the offers.

As shown at 608, upon another indication from the media provider 250, the feed to the media renderer is switched back from the stream transmitted by the client terminal 101 to the original media content stream received from the media provider 150.

Optionally, the plurality of media consumers 230 using a plurality of client terminals 101 subscribe to one or more social groups. The media consumers 230 who are subscribed to a social group may be involved in a social interaction with other members of the group, for example, receive purchase orders, submit recommendations, vote for products and/or share views. The media consumers 230 who are members of the social group may, for example, post requests for vendors to make an offer on a product and/or a service that is desired by the members of the group.

Reference is now made to FIG. 5 which is a flowchart of an exemplary process for posting a new group purchasing, according to some embodiments of the present invention. A process 700 may be executed locally by the processor component 212 of the client terminal 101, by the processor component 221 of the central unit 201 and/or the process 600 may be distributed between the processor component 212 and the processor component 221.

As shown at 701, a personal profile may be created to reflect interaction of the media consumer 230 with the presented media content and/or the commercial content.

As shown at 702, the media consumer 230 who is a subscribed to the social group may view a plurality of lists which include currently posted group purchase offers.

As shown at 703, the media consumer 230 who is a subscribed to the social group may view a plurality of lists of potential products and/or services providers.

As shown at 704, upon indication from the media provider 150, the feed to the media renderer is switched from the original media content stream to the client terminal 101.

As shown at 705, the media consumer 230 may generate a post for a new purchasing group

As shown at 706, a message of the new post is sent to the media consumers 230 who are subscribed to the social group.

As shown at 707, a message of the new post is sent to the media consumers 230 who are subscribed to the social group.

As shown at 708, one or more media consumers 230 who are subscribed to the social group may interact with each other in order to finalize an offer for a purchasing group.

As shown at 709, after the media consumers 230 who are subscribed to the social group and are interested in the posted product and/or service, a commitment is made to the one or more vendors for making the purchase.

As shown at 710, upon another indication from the media provider 150, the feed to the media renderer is switched back from the stream transmitted by the client terminal 101 to the original media content stream received from the media provider 150.

1. A computerized method of personalizing commercial content to be presented to at least one media consumer, comprising:
identifying an interaction held between a plurality of media consumers who use a plurality of client terminals and simultaneously presented by said plurality of client terminals with media content received from a media provider, said interaction being held during a joint session simultaneously engaging said plurality of media consumers in at least one session activity;
gathering consumer data on at least one of said plurality of media consumers;
computing a personalized commercial content for at least one product or service based on an analysis of said interaction and said consumer data; and
distributing said personalized commercial content for presentation on at least one of said plurality of client terminals.

2. The method of claim 1, wherein said personalized commercial content includes at least one member of a group consisting of: advert, promotion data and purchase offer.

3. The method of claim 1, wherein said personalized commercial content is a group purchasing offer for said at least one product or service.

4. The method of claim 1, wherein said distributing further comprises enabling at least one of said plurality of media consumers to interact with at least one vendor that offers said at least one product or service that is presented in said personalized commercial content.

5. The method of claim 1, wherein said distributing is enabled while said plurality of client terminals presents said media content simultaneously to said plurality of media consumers.

6. The method of claim 1, further comprising enabling said at least one media consumer to interact with at least one other media consumer of said plurality of media consumers at a remote location that is interested in at least one item that is presented in said personalized commercial content.

7. (canceled)

8. The method of claim 1, wherein said presenting is performed after receiving a description of said media content from said media provider, said description is used to create said personalized commercial content.

9. The method of claim 8, wherein said description includes a time period during which said presenting takes place.

10-17. (canceled)

18. The system of claim 30, wherein said system shares a common data repository with a plurality of joint session modules executed on said plurality of client terminals.

19-23. (canceled)

24. A method of presenting personalized commercial content to a media consumer, comprising:
creating a personal profile of a media consumer, said personal profile reflects real time interaction of said media consumer with at least one other media consumer; and
presenting a personalized commercial content to said media consumer according to said personal profile.

25-26. (canceled)

27. A method of tracking real time interaction of a media consumer with at least one other media consumer, comprising:
establishing a joint session with a plurality of media consumers using a plurality of interaction modules installed in a plurality of client terminals, wherein during said joint session said plurality of client terminals simultaneously presents a common media content and a graphical user interface for establishing a real time interaction on displays of said plurality of client terminals;
monitoring a respective said real time interaction of a media consumer of said plurality of media consumers with at least one other media consumer of said plurality of media consumers;
analyzing said real time interaction to identify social interests of said media consumer;
creating personalized commercial content to meet said social interests; and
presenting said personalized commercial content to said media consumer using a display of one of said plurality of client terminals.

28. (canceled)

29. The method of claim 1, wherein the distributing of the personalized commercial content is done during an interaction that is later than an interaction in which the gathering of consumer data is done.

30. A system of personalizing commercial content to be presented to at least one media consumer, comprising:
a monitor component adapted to identify an interaction held between a plurality of media consumers who use a plurality of client terminals and simultaneously presented by said plurality of client terminals with media content received from a media provider, said interaction being held during a joint session simultaneously engaging said plurality of media consumers in at least one session activity, said monitor component is adapted to gather consumer data on at least one of said plurality of media consumers;
a media control component adapted to compute a personalized commercial content for at least one product or service based on an analysis of said interaction and said consumer data; and
a communication component adapted to distribute said personalized commercial content for presentation on at least one of said plurality of client terminals.

31. A computerized method of personalizing commercial content to be presented to at least one media consumer, comprising:
identifying an interaction held between a plurality of media consumers who use a plurality of client terminals and simultaneously presented by said plurality of client terminals with media content received from a media provider, said interaction being held during a joint session simultaneously engaging said plurality of media consumers in at least one session activity;
analyzing said interaction to identify social interests of a first media consumer of said plurality of media consumers;
creating personalized commercial content to meet said social interests; and
distributing said personalized commercial content for presentation on said client terminal of said first media consumer.

32. The method of claim 3, further comprising managing a group purchasing session wherein said plurality of media consumers are offered to accept said group purchasing offer for purchasing said at least one product or service.

33. A computer program product for a computerized method of personalizing commercial content to be presented to at least one media consumer, comprising:
a non transitory computer readable storage medium;
first program instructions for identifying an interaction held between a plurality of media consumers who use a plurality of client terminals and simultaneously presented by said plurality of client terminals with media content received from a media provider, said interaction being held during a joint session simultaneously engaging said plurality of media consumers in at least one session activity;
second program instructions for gathering consumer data on at least one of said plurality of media consumers;
third program instructions for computing a personalized commercial content for at least one product or service based on an analysis of said interaction and said consumer data; and
fourth program instructions for distributing said personalized commercial content for presentation on at least one of said plurality of client terminals;
wherein said first, second, third, and fourth program instructions are stored on said computer readable storage medium.
